(19) United States
(12) Patent Application Publication
(10) Pub. No.: US 2007/0006918 A1
(43) Pub. Date: Jan. 11, 2007

(54) Float type drain trap

(76) Inventor: Hiroshi Yamamoto, Yao (JP)

Correspondence Address: WENDEROTH, LIND & PONACK, L.L.P., 2033 K STREET N. W., SUITE 800, WASHINGTON, DC, 20006-1021, US

(21) Appl. No.: 11/282,627

(22) Filed: Nov. 21, 2005

(30) Foreign Application Priority Data
Jul. 7, 2005 (JP) 2005-198233

(51) Int. Cl. F16T 1/20

(52) U.S. Cl. 137/195

(57) ABSTRACT

The present invention provided a float type drain trap capable of preventing penetration of foreign matters into the pilot valve to eliminate troubles caused with penetration of foreign matters, furnishing the pilot valve operation with stability and function of snap action, and reducing the bore diameter of the pilot valve to make the float as small as possible.

The pilot valve mechanism is constructed by comprising a pilot valve 7, disposed in part of the pilot chamber 8 and putting the pilot chamber 8 in communication with the outside of the drain case 1, an orifice 9, formed on the upstream side of the pilot valve 7 and putting the pilot chamber 8 in communication with the inside of the drain case 1, and a microfilter 10 provided on the orifice 9, and a permanent magnet 11 is provided on said pilot valve 7, while on said float 6 is provided a permanent magnet 12 for operating the pilot valve 7 in repellence to the permanent magnet 11.

### BACKGROUND OF THE INVENTION

The present invention concerns a float type drain trap used for automatically discharging the drain contained in compressed air.

A float type drain trap is realized, as shown in FIG. 2 or FIG. 3, by providing, on a piston 5 stored in a cylinder 4, a drain valve 3 for opening/closing the discharge port 2 of a drain case 1 and also providing a pilot valve mechanism for opening the drain valve 3 by making pilot air pressure act on the piston 5, to open/close the pilot valve 7 of said pilot valve mechanism with up-down motions of a float 6 disposed on the outside of said cylinder 4.

In that case, a conventional float type drain trap as shown in FIG. 2 or FIG. 3 adopts a system of directly opening/closing the pilot valve 7 with the buoyancy of the float 6 in the majority of cases. However, a problem with this system is that the mechanism for transmitting the motions of the float 6 to the pilot valve 7 is exposed and it is impossible to provide a filter 10 in this portion, and this makes it impossible to prevent penetration of harmful foreign matters into the pilot valve 7, frequently producing troubles such as operating error due to clogging of the pilot valve 7, or air leak due to biting of foreign matters in the pilot valve 7, etc.

Moreover, with a conventional float type drain trap, it was rather difficult to obtain snap actions of the pilot valve 7, because of the construction in which the pilot valve 7 is operated directly with the motions of the float 6, presenting a problem of half-open state of the pilot valve 7 or the drain valve 3.

Furthermore, with a conventional float type drain trap, constructed in such a way that the pilot valve 7 is operated directly with the motions of the float 6, the pressure control system of the pilot chamber 8 by opening/closing of the pilot valve 7 is restricted only to a system of producing a differential pressure by discharging part of that air pressure through an orifice 9, while supplying air pressure to the pilot chamber 8 by opening the pilot valve 7, and this makes it necessary to make the bore diameter of the pilot valve 7 fairly larger than the bore diameter of the orifice 9, also requiring, for that purpose, a large float 6 for operating the pilot valve 7.

And, as means for compensating for this defect of requiring a large float 6 and making the float 6 as small as possible, a mechanism is adopted which amplifies the buoyancy of the float by means of a lever 16, etc. at the connecting portion between the float 6 and the pilot valve 7. However, this complicates the construction, frequently presenting troubles due to problems in the connecting portion.

### SUMMARY OF THE INVENTION

In view of said problems inherent in the conventional float type drain traps, the objective of the present invention is to provide a float type drain trap capable of preventing penetration of foreign matters into the pilot valve to eliminate troubles caused with penetration of foreign matters, by providing a filter in the inlet route of pilot air pressure to be fed to the pilot through an orifice, furnishing the pilot valve operation with stability and function of snap action, by indirectly operating the pilot valve from outside by utilizing magnetic force, and also capable of reducing the bore diameter of the pilot valve to make the float as small as possible, by adopting a pilot air pressure control system in which the orifice is disposed on the upstream side of the pilot valve.

To achieve said objective, the float type drain trap according to the present invention is a float type drain trap realized by providing a drain valve for opening/closing the discharge port of a drain case on a piston stored in a cylinder, and also providing a pilot valve mechanism for opening the drain valve by making pilot air pressure act on the piston, to open/close the pilot valve of said pilot valve mechanism with up-down motions of a float disposed on the outside of said cylinder, characterized in that

said pilot valve mechanism is constructed by comprising a pilot valve, disposed in part of the pilot chamber and putting the pilot chamber in communication with the outside of the drain case, an orifice, formed on the upstream side of the pilot valve and putting the pilot chamber in communication with the inside of the drain case, and a filter provided on the orifice,

a permanent magnet is provided on said pilot valve, and that

on said float is provided a permanent magnet for operating the pilot valve in repellence to that permanent magnet.

According to the float type drain trap of the present invention, it becomes possible to indirectly operate the pilot valve with a magnetic force acting between the permanent magnet provided on the pilot valve and the permanent magnet provided on the float. Moreover, because the repulsion of the two permanent magnets is proportional to the amount of lifting of the float, the repulsion of the magnets gradually increases as the float goes up and, when that repulsion exceeds the back pressure acting on the pilot valve, the pilot valve opens instantly and, in addition, the float further goes up because the back pressure decreases and the load on the float lessens with the opening of the pilot valve, thus enabling to provide a function of snap action for fully opening the pilot valve accurately, to thereby perform stable discharge of drain in a wide operating pressure range from low pressure to high pressure.

Furthermore, this float type drain trap, which indirectly operates the pilot valve with a magnetic force, enables to provide an orifice and a filter in the inlet route of pilot air pressure in the upstream of the pilot valve, to thereby prevent penetration of harmful foreign matters into the pilot valve and reduce troubles of the pilot valve due to penetration of foreign matters.

And, by disposing the orifice on the upstream side of the pilot valve, it becomes possible to reduce the bore diameter of the pilot valve to a size about the same as that of the orifice, thus reducing the float size.

Still more, with a conventional float type drain trap, the control system of pilot air pressure is restricted and there is no choice but adopt a spool valve system as system of the drain valve, and this results in damaging of the drain valve in short period in some cases because the stroke of the piston and of the drain valve becomes longer in the spool valve system. With the float type drain trap of the present invention, however, a wider choice of pilot air pressure control system enables to adopt a poppet valve system, and a poppet valve system can reduce troubles of the drain valve thanks to simple valve structure and possibility of shortening of stroke.

And, while a conventional float type drain trap required a mechanism for connecting between the pilot valve and the float and troubles were liable to be produced because of a failure of this mechanism, the float type drain trap of the present invention, which does not require any such mechanism, can eliminate troubles of this kind.

### BRIEF DESCRIPTION OF THE DRAWINGS

FIG. 1 is a sectional view showing an embodiment of the float type drain trap according to the present invention.

FIG. 2 is a sectional view showing an example of conventional float type drain trap.

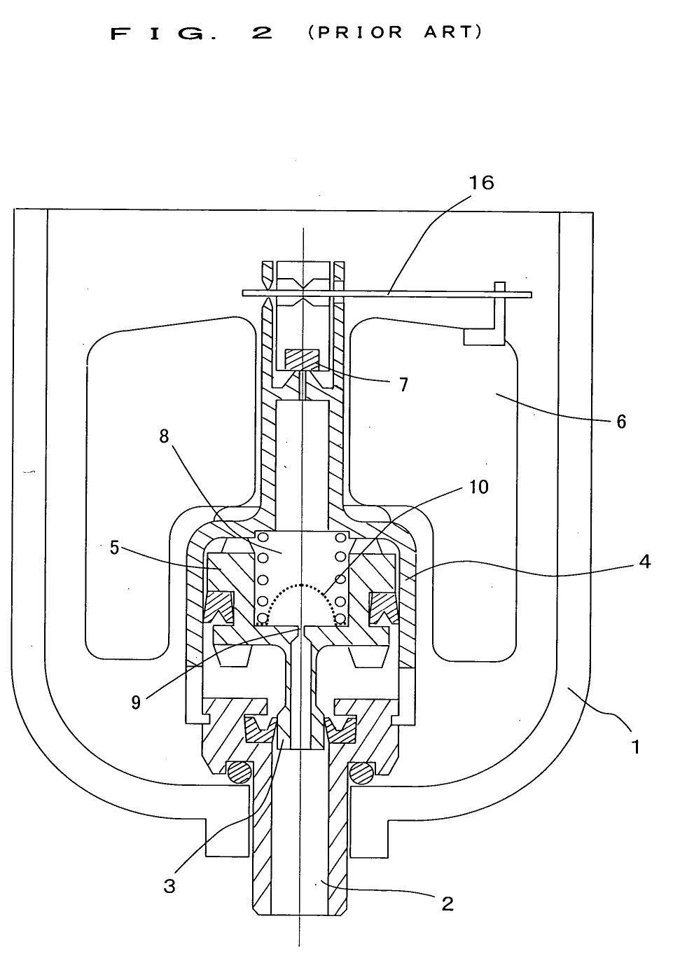

FIG. 3 is a sectional view showing another example of conventional float type drain trap.

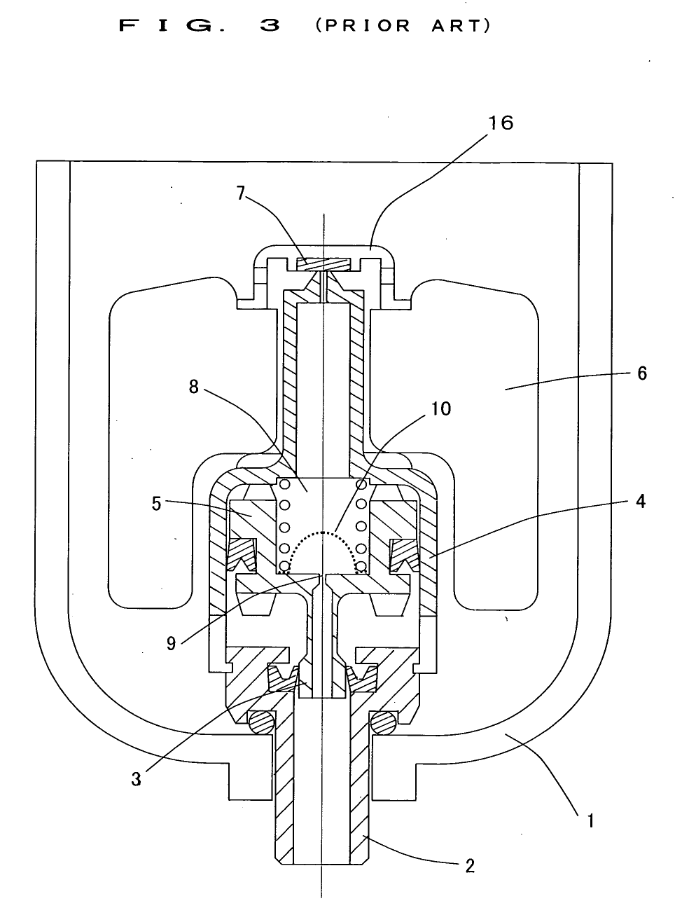

### DETAILED DESCRIPTION OF THE INVENTION

An embodiment of the float type drain trap according to the present invention will be explained hereafter, with reference to drawings.

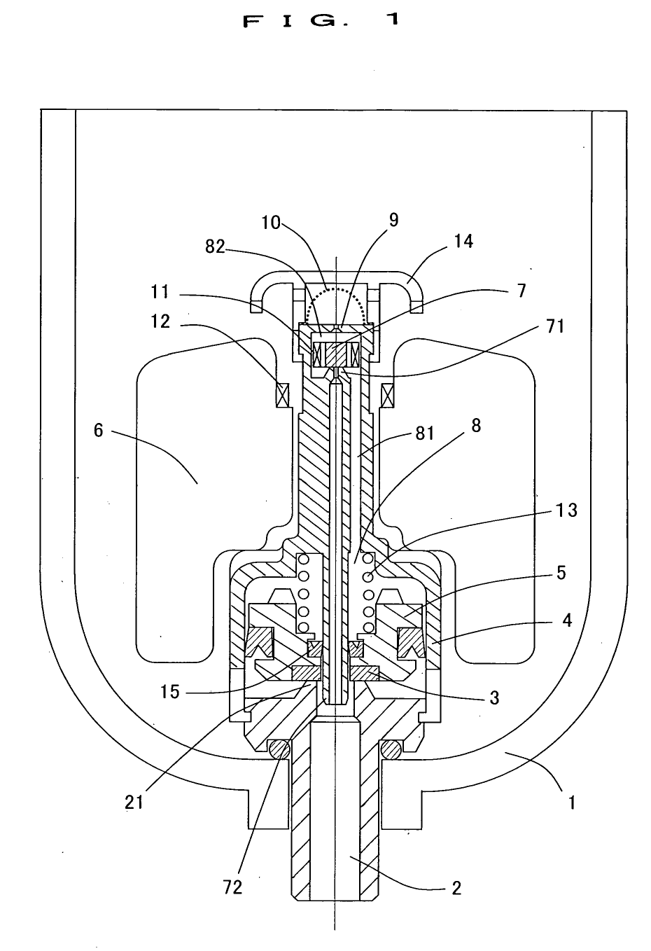

FIG. 1 shows an embodiment of the float type drain trap according to the present invention.

This float type drain trap is realized by providing a drain valve 3 for opening/closing the discharge port 2 of a drain case 1 on a piston 5 stored in a cylinder 4, and also providing a pilot valve mechanism for opening the drain valve 3 by making pilot air pressure act on the piston 5, to perform opening/closing of the pilot valve 7 of said pilot valve mechanism with up-down motions of a float 6 disposed on the outside of said cylinder 4.

And, in this float type drain trap, said pilot valve mechanism is constructed by comprising a pilot valve 7, disposed in part of the pilot chamber 8 and putting the pilot chamber 8 in communication with the outside of the drain case 1, an orifice 9, formed on the upstream side of the pilot valve 7 and putting the pilot chamber 8 in communication with the inside of the drain case 1, and a filter 10 (preferably a microfilter) provided on the orifice 9, and said pilot valve 7 is provided with a permanent magnet 11 while said float 6 is provided with a permanent magnet 12 for operating the pilot valve in repellence to the permanent magnet 11.

The drain case 1 is installed in a pipeline, etc. of compressed air, and at the center of its bottom is provided a discharge port 2 of drain.

Above the discharge port 2 is fixed a cylinder 4, and inside the cylinder 4 is stored a piston 5 in a way movable up and down.

The piston 5 is urged downward by a spring 13 disposed on it, and closes the valve seat 21 of the discharge port 2 with the drain valve 3 provided at the tip.

The piston 5 is pushed up with the pressure inside the drain case 1 to open the drain valve 3, as the pilot valve 7 opens and that the pilot chamber 8 is left open to the outside of the drain case 1.

The spring 13 is an auxiliary spring for accurately closing the drain valve 3 after the discharge of drain.

Moreover, inside the cylinder 4, the pilot chamber 8 acted upon by pilot air pressure is partitioned by the piston 5.

The pilot chamber 8 forms a small chamber 82 communicated through a communication route 81 at the top of the cylinder 4, and the pilot valve 7 is disposed in this small chamber 82.

The pilot valve 7 opens/closes the valve seat 71 formed at the bottom of the small chamber 82 and, in the open state, discharges the air in the pilot chamber 8 through an exhaust pipe 72, by putting the pilot chamber 8 in communication with the outside of the drain case 1.

To the outer circumference of the pilot valve 7 is fixed a ring-shaped permanent magnet 11 repellent to a permanent magnet 12 of the float 6.

Furthermore, in the top wall of the small chamber 82 is formed an orifice 9 which puts the pilot chamber 8 and the inside of the drain case 1 in communication with each other, and above the orifice 9 are installed a filter 10 and a filter cover 14 protecting the filter 10.

The exhaust pipe 72 is provided in extension to the exhaust port 2 through the piston 5, and a packing 15 is disposed on the sliding part of the piston 5.

Still more, the filter 10 is made of a net with a mesh size sufficiently smaller than the hole diameter of the orifice 9 and of the valve seat 71 of the pilot valve 7.

The float 6, made of a general float in foamed nitrile rubber or a hollow float in plastic with automatic draining function, is slidably disposed on the outer circumference at the top of the cylinder 4.

On the inner circumference at the top of the float 6 is a ring-shaped permanent magnet 12 which operates the pilot valve 7 in repellence to the permanent magnet 11 of the pilot valve 7, when the float 6 went up and came close to the pilot valve 7.

The permanent magnet 11 of the pilot valve 7 and the permanent magnet 12 of the float 6 are ring-shaped anisotropic permanent magnets and are disposed in the orientation to be repellent to each other, but a slight attraction works between them in the case where they are away from each other by more than a specific distance.

Next, explanation will be made on the actions of the float type drain trap according to the present invention, based on FIG. 1.

The state in FIG. 1 shows a state in which there is no drain and that the float 6 is at the bottom end, under a certain pressure.

Since a slight attraction works between the permanent magnet 11 and the permanent magnet 12 in this state and that a back pressure also acts on the pilot valve 7, the pilot valve 7 remains in closed state.

Into the pilot chamber 8 is introduced air pressure from inside the drain case 1, through the filter 10 and the orifice 9, and the pressure on the upper side of the piston 5 is the same as the pressure inside the drain case 1.

As a result, the piston 5 is not subject to any upward output but is pushed down, on the contrary, with the force of the spring 13 and the back pressure acting on the drain valve 3, and the drain valve 3 remains closed.

Next, as drain flows into the drain case 1 and the float 6 goes up, the permanent magnet 11 and the permanent magnet 12 come closer to each other producing repulsion between the two magnets and, if that repulsion exceeds the back pressure acting on the pilot valve 7, the pilot valve 7 opens instantly.

If the pilot valve 7 opens, the air in the pilot chamber 8 is discharged to outside through the pilot valve 7 and, from the relation between the volume of that discharged air and the inflow air volume flowing in through the orifice 9 from inside the drain case 1 i.e. the relation of effective surface area between the orifice 9 and the pilot valve 7, the pressure in the pilot chamber 8 becomes lower than the pressure inside the drain case 1 and the drain valve 3 opens, because of the differential pressure produced between the upper side and the lower side of the piston 5, to discharge the drain in the drain case 1 to outside.

In the case where, after the drain is discharged and the float 6 comes down, there is no more magnetic force acting on the pilot valve 7 or a slight attraction acts on the contrary, the pilot valve 7 closes and the discharge of the air from inside the pilot chamber 8 stops.

And, as air flows into the pilot chamber 8 through the orifice 9, the pressure in the pilot chamber 8 recovers up to the pressure in the drain case 1 and no output to the piston 5 is made any longer. As a result, the piston 5 recovers, and the drain valve 3 closes, to return to the initial state.

As described above, the float type drain trap of this embodiment can indirectly operate the pilot valve 7 with a magnetic force acting between the permanent magnet 11 provided on the pilot valve 7 and the permanent magnet 12 provided on the float 6. Moreover, because the repulsion between the two magnets is proportional to the amount of lifting of the float 6, the repulsion of the magnets gradually increases as the float 6 goes up and, when that repulsion exceeds the back pressure acting on the pilot valve 7, the pilot valve 7 opens instantly and, in addition, the float 6 further goes up because the back pressure decreases and the load on the float 6 lessens with the opening of the pilot valve 7, thus enabling to provide a function of snap action for fully opening the pilot valve 7 accurately, to thereby perform stable discharge of drain in a wide operating pressure range from low pressure to high pressure.

Furthermore, this float type drain trap, which indirectly operates the pilot valve 7 with a magnetic force, enables to provide an orifice 9 and a filter 10 in the inlet route of pilot air pressure in the upstream of the pilot valve 7, to thereby prevent penetration of harmful foreign matters into the pilot valve 7 and reduce troubles of the pilot valve 7 due to penetration of foreign matters.

And, by disposing the orifice 9 on the upstream side of the pilot valve 7, it becomes possible to reduce the bore diameter of the pilot valve 7 to a size about the same as that of the orifice 9, thus reducing the size of the float 6.

Still more, with a conventional float type drain trap, the control system of pilot air pressure is restricted and there is no choice but adopt a spool valve system as system of the drain valve, and this results in damaging of the drain valve in short period in some cases because the stroke of the piston and the drain valve becomes longer in the spool valve system. With the float type drain trap of the present invention, however, a wider choice of pilot air pressure control system enables to adopt a poppet valve system, and a poppet valve system can reduce troubles of the drain valve thanks to simple valve structure and possibility of shortening of stroke.

And, while a conventional float type drain trap required a mechanism for connecting between the pilot valve and the float and troubles were liable to be produced because of a failure of this mechanism, the float type drain trap of the present invention, which does not require any such mechanism, can eliminate troubles of this kind.

Explanation has so far been made on the float type drain trap according to the present invention based on an embodiment thereof. However, the present invention is not restricted to the construction described in said embodiment, but its construction can be changed as required within the range not deviating from its purport, by such means as combining as required the constructions described in the embodiment, etc.

The float type drain trap according to the present invention can be used suitably for applications of compact and highly functional drain trap, for its characteristics of preventing penetration of foreign matters into the pilot valve, by providing a filter in the inlet route of pilot air pressure, of furnishing the pilot valve operation with stability and function of snap action, by indirectly operating the pilot valve from outside by utilizing magnetic force, and of reducing the bore diameter of the pilot valve to make the float as small as possible, by disposing an orifice on the upstream side of the pilot valve.

1. A float type drain trap realized by providing a drain valve for opening/closing the discharge port of a drain case on a piston stored in a cylinder, and also providing a pilot valve mechanism for opening the drain valve by making pilot air pressure act on the piston, to open/close the pilot valve of said pilot valve mechanism with up-down motions of a float disposed on the outside of said cylinder, characterized in that
said pilot valve mechanism is constructed by comprising a pilot valve, disposed in part of the pilot chamber and putting the pilot chamber in communication with the outside of the drain case, an orifice, formed on the upstream side of the pilot valve and putting the pilot chamber in communication with the inside of the drain case, and a filter provided on the orifice,
a permanent magnet is provided on said pilot valve, and that
on said float is provided a permanent magnet for operating the pilot valve in repellence to that permanent magnet.
